(19) United States
(12) Patent Application Publication
(10) Pub. No.: US 2014/0090607 A1
(43) Pub. Date: Apr. 3, 2014

(54) APPARATUS FOR BRUSHING CATTLE

(71) Applicant: ALPHA TECHNOLOGY U.S.A. CORPORATION, Longwood, FL (US)

(72) Inventors: Kevin Dole, Longwood, FL (US); Larry Bilskie, Winter Springs, FL (US)

(73) Assignee: ALPHA TECHNOLOGY U.S.A. CORPORATION, Longwood, FL (US)

(21) Appl. No.: 14/043,308

(22) Filed: Oct. 1, 2013

Related U.S. Application Data
(60) Provisional application No. 61/708,233, filed on Oct. 1, 2012.
(60) Provisional application No. 61/788,590, filed on Mar. 15, 2013.

(51) Int. Cl. A01K 13/00

(52) U.S. Cl. CPC A01K 13/001
USPC 119/609

(57) ABSTRACT

An apparatus for brushing cattle comprises a motor mounted to a fixed support structure, and the motor remains stationary during operation of the apparatus. A pivotal motor output shaft assembly is operatively connected to the motor, and disposed vertically and downwardly relative the motor; and, a brush is attached to the shaft assembly distal to the motor, wherein the motor drives the output shaft causing the brush to rotate. The motor may have a longitudinal disposed and a gear assembly is connected to the motor and the output shaft assembly. The shaft assembly is pivotal at a location along the shaft location between the brush and the motor and/or gear assembly.

### CROSS-REFERENCE TO RELATED APPLICATIONS

This application claims the benefit of U.S. Provisional Application No. 61/708,233 filed Oct. 1, 2012, and U.S. Provisional 61/788,590 filed Mar. 15, 2013, and incorporated herein by reference in their entirety.

### BACKGROUND OF THE INVENTION

The present invention relates to an apparatus, equipment, systems or methods for brushing cattle. More specifically, the invention relates to brushes that are mounted at areas of cattle traffic and are operatively connected to a motor to rotate for grooming a cow.

it is generally accepted that grooming dairy cattle provides some biological importance to the cows. In addition to cleaning the cows, grooming cattle with brushes also reduces the number of parasites and organisms in a cow's coat. It is also believed that stress on cattle may adversely affect milk production and that grooming cows reduces stress.

Brushes may be mounted at one or more locations in aisles or crosswalks of housing areas to groom cows before or after milking. There are various types of stationary brushes and rotating brushes that are used in which cattle rub against the brush for grooming. Some rotating brushes may be suspended from a pivoting carriage and pivot to various angles as a cow pushes against the brush. Some brushes may pivot to a generally horizontal position to groom the back of a cow.

A prior art apparatus for brushing cattle is disclosed in EP 2 119 346 to Agricow S.r.l. and includes a motor assembly and gear assembly that are mounted on a pivoting bracket assembly. A brush is operatively connected to the gear assembly which is connected to a rotating shaft of the motor. The bracket enables oscillation of the brush in at least two planes orthogonal to each other. Similar systems on the market are configured such that when a cow engages the brush the motor is activated and the brush begins to rotate. When the cow pushes against the brush, the pivoting bracket, with the motor and gear assembly on it, pivots. Thus the motor and gear assembly are inclined during operation, which places an unnecessary strain on these components shortening the life of the components.

In addition, such apparatuses have brushes that have a length of at most thirty inches and the brushes are suspended at heights wherein only the head, neck and body of the cow are groomed and not the legs of the animal. Moreover, the pivoting parts of the apparatus are positioned relative to an end of the brush whereby certain body parts on the head of the cow, or buckles or tags on the cow, can get caught in the moving parts causing injury to the cow. Some dairies that breed dairy cattle using stud bulls apply heat strips to the backs of cattle. The heat strips are color responsive to heat generated by the cattle at times of breeding. Rotating brushes that contact the back of cows can remove or otherwise cause the heat strips not to function properly.

### BRIEF DESCRIPTION OF THE DRAWINGS

The invention is explained in the following description in view of the drawings that show:

FIG. 1 is a perspective view of an embodiment in accordance with the invention.

FIG. 2 is a side elevational view of the embodiment of the invention shown in FIG. 1.

FIG. 3 is a side elevational view of a cow engaging the brush causing the brush to pivot.

FIG. 4 is a perspective view of an embodiment of the invention cattle brush assembly that includes a hinge mount having been opened.

FIG. 5 is a perspective view of the embodiment of the invention shown in FIG. 5 with the hinge mount in a closed position.

FIG. 6 is a side elevational view of an embodiment of the invention including a flexible shaft operatively connected to the brush.

### DETAILED DESCRIPTION OF THE INVENTION

A more particular description of the invention will be rendered by reference to specific embodiments thereof that are illustrated in the appended drawings. Understanding that these drawings depict only typical embodiments of the invention and are not therefore to be considered to be limiting of its scope, the invention will be described and explained.

The inventors have developed an apparatus 10 for brushing cattle that provides a brush that is of sufficient length to groom the head, body and legs of a cow. In addition, the brush 16 is positioned at a height above the ground to prevent the brush 16 from being tilted to an undesired angle. In a non-limiting example, the brush 16 cannot be tilted to an angle that exceeds 60° from a vertical axis of the brush 16 and/or shaft assembly 14. In addition, the motor 12 and gear assembly 22 remain stationary during operation and are not tilted with pivoting movement of the brush 16, which may unnecessarily places stress on those components. Also, a pivoting joint is provided at a location of the shaft assembly 14 between the brush 16 and motor providing a pivoting range of 360°.

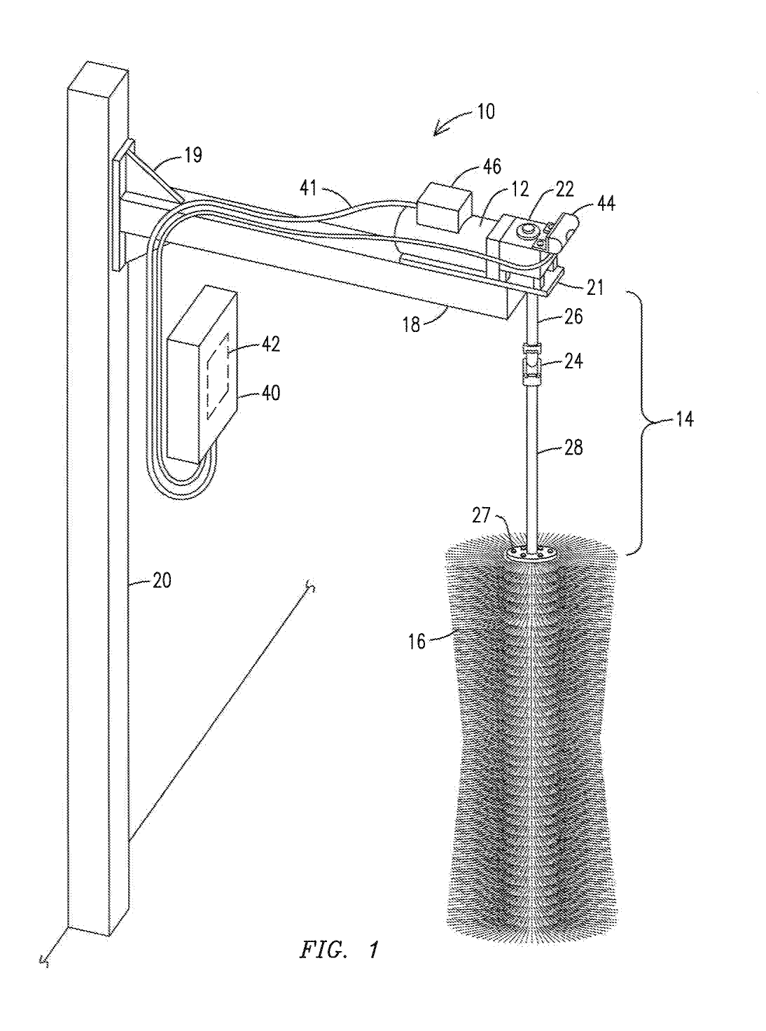

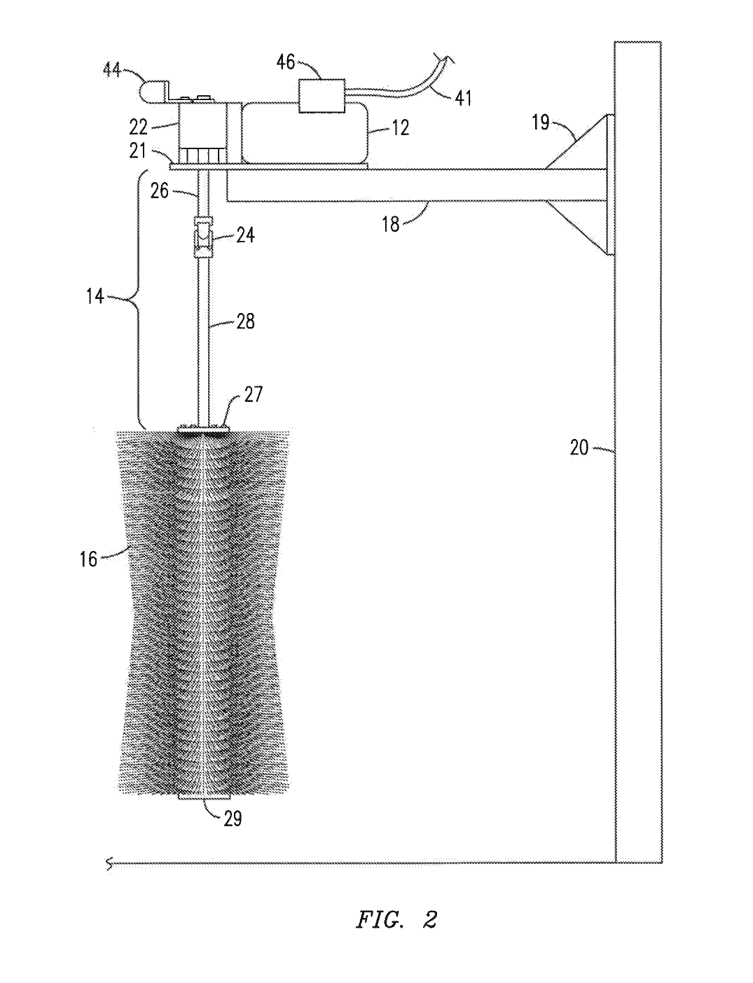

An embodiment of the system or apparatus 10 for brushing cattle is illustrated in FIGS. 1-3 and includes a motor 12 that drives output shaft assembly 14 to rotate a brush 16. The motor 12 is mounted to a support beam 18, which is in turn mounted to a fixed structure such as a post 20 with a bracket 19. The post 20 may be further mounted against a wall in a housing area through which cattle may walk. While the apparatus 10 is shown mounted to a post 20, the apparatus may be mounted to any structure that will support the apparatus and is located in area through which cattle travel for grooming.

The output shaft assembly 14 is operatively connected to the motor 12 via a gear assembly 22. The output shaft assembly 14 is capable of pivoting or flexing at a location along the assembly 14 between the brush 16 and. gear assembly 22 and motor 12. Accordingly, the output shaft assembly 14 may comprise a pivotal and/or rotating coupling or joint 24, such as a universal joint, that operatively connects a first shaft 26 to a second shaft 28. The first shaft 26 is connected to the gear assembly 22 and the second shaft 28 is connected to the brush 16 to rotate the brush 16 about its longitudinal axis.

In a non-limiting example, the brush 16 is about four feet long and has an inverted truncated conical shape wherein the maximum outer diameters (i.e., 18 inches) of the brush are at the respective opposite ends of the brush 16. Accordingly, the beam 18 must be of sufficient size to support the motor 12, shafts 26, 28 and brush 16. By way of example, the beam 18 may be a 3.5″×3.5″ square tube made of iron, steel or other material of sufficient strength to support the suspended brush 16 and other components.

The motor may be a ½ horse power 200 to 480 VAC one or three-phase motor, which operates at sufficient speed to produce a torque output to rotate the brush 16, which, as explained above may be about 48 inches in length or height. Such a motor may operate to rotate the brush 16 at a rotational speed of about 60 rpms. As shown, the motor 12 and gear assembly 22 are mounted to a mounting plate 21 at a free end of the beam 18 distal to the bracket 19. The first shaft 26 is operatively connected to the gear assembly 22 through a hole in the mounting plate 21. Also, the beam 18 should be long enough so that brush 16 is spaced from a support structure, to which the beam 18 is mounted, a distance that enables free movement of the brush 16 without engaging the support structure. For a 48″ brush the beam 18 may be a little over 4 feet long. In addition, the mounting plate 21 is positioned on the beam 18 such that the shafts 26, 28 are spaced about 60° from the support structure or post 20 taking into consideration the thickness of the mounting bracket 19.

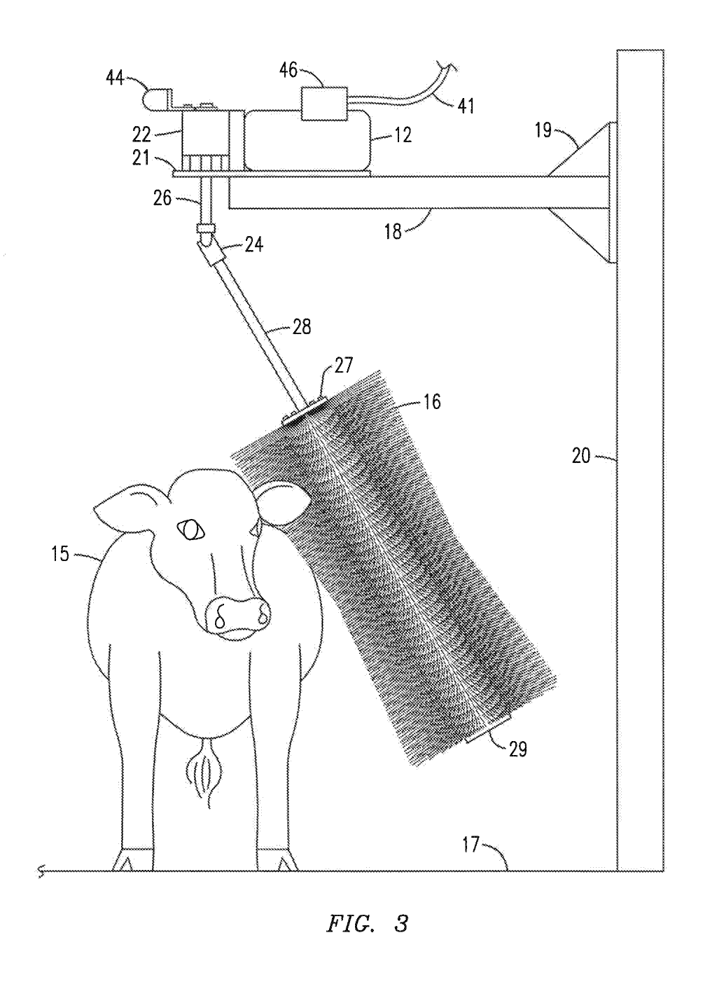

The beam 18, shafts 26, 28 and brush 16 are positioned such that the rotating or pivoting joint 24 is at a height above a floor 17 and/or a cow 15 (FIG. 3) so that the animal cannot physically touch or engage the movement part, which could injure the animal. In addition, the brush 16 is preferably positioned a certain height off the ground to prevent a cow from pushing the brush 16 to such an angle that may cause the joint 24 to lock or freeze. For example, the brush 16 may be so positioned relative to the ground 17 so that it may be pivoted up to an angle of about 60° from a vertical central axis of the shafts 26, 28 and brush 16. In an embodiment in which a 48 inch brush is incorporated, an underside of the beam 18 is about 80 to 90 inches elevated above the ground, and preferably about 88 inches above the ground so the bottom of the brush is about 25 inches off the ground. The first shaft 26, which is operatively connected to the gear assembly 22 at one end and the coupling or joint 24 at the other end, may be about 9 inches long and the second shaft 28 may be about 60 inches long so the bottom end of the brush 16 is about 25 inches off floor or ground 17. In such an example even a large Holstein cow having shoulder height up to 60 inches cannot tilt the brush 16 past an angle of about 60° from vertical.

In the embodiments shown in FIGS. 1-5, the motor 12 is mounted on beam 18 such that a longitudinal axis of the motor is horizontally disposed and the gear assembly 22 is operatively connected to a horizontally disposed rotating output shaft of the motor 12. In such an embodiment, the gear assembly 22 may be a helical gear assembly with a 30:1 gear reduction ratio. In an alternate embodiment, the motor 22 may be vertically disposed and positioned on the mount plate 19 and/or beam 18 so that its rotary output shaft of the motor 12 is directly coupled to the shaft assembly 14 without the need of an interposed gear assembly. In such an embodiment, a larger motor, such as a 15 hp motor, may be required to rotate a brush as large as 48 inches in length.

As shown in FIGS. 1-3, the second shaft 28 includes a top mounting disc 27 and bottom mounting disc 29 for attachment of the brush 16 to the second shaft 28 and shaft assembly 14. The brush 16 may have a cylindrical hollow core through which the second shaft 28 extends. In a preferred embodiment this core may be made of a polypropylene material that may receive fasteners such as tap screws to fix the brush 16 to the top mounting disc 27 and the second shaft 28. To that end, the top mounting disc 27 is affixed to the second shaft 28. Once the brush 16 is fixed to the top mounting disc 27, the bottom mounting disc 29 is fixed to the bottom end of the core of the brush 16. The shafts 26, 28 are preferably solid rods, so the shaft 28 may be equipped with a bottom plate that is keyed to receive a metal dowel on the bottom mounting disc 29. The brush 16 is preferably fixed to the shaft 28, which is then attached to the universal joint 24 on the first shaft 26. During operation, the motor 12 drives the gear assembly 22 and shaft assembly 14 to rotate the brush 16. The universal coupling or joint 24 allows the brush 16 to pivot in any direction or has 360° range of pivoting motion.

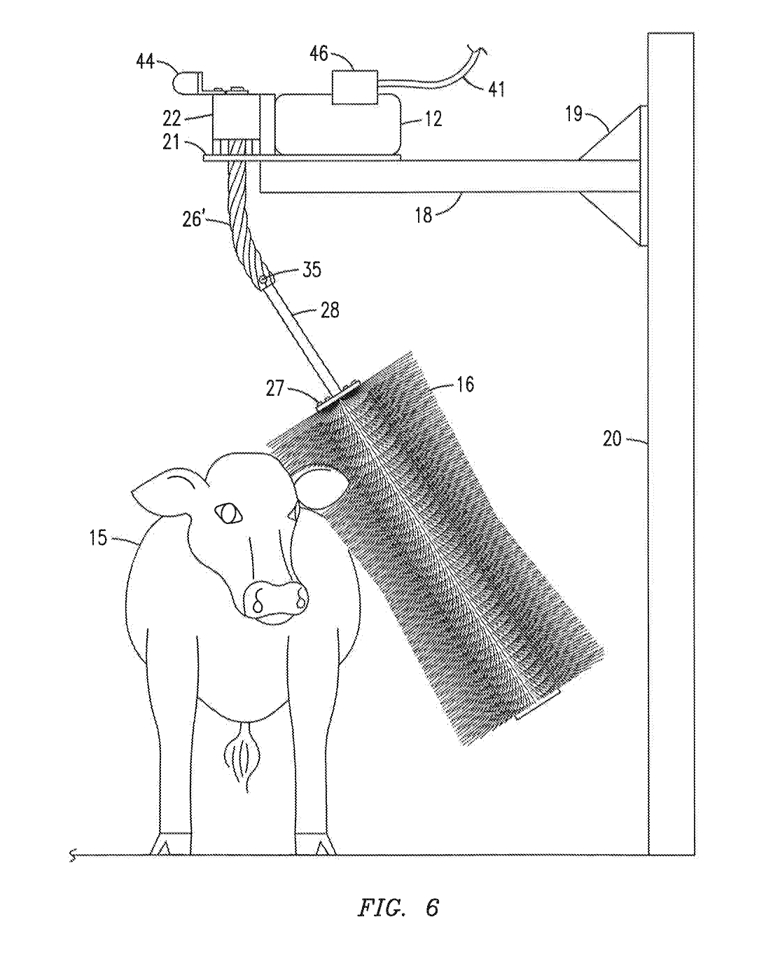

With respect to FIG. 6, another embodiment is shown in which the pivotal shaft assembly 14 includes a first shaft 26′ that is composed of a flexible material that is composed of a material of sufficient strength to support the second shaft 28 and brush 16. In a non-limiting example, the first shaft 26′ is a steel cable that is adapted to connect to the gear assembly 22 at one end and the second shaft 28 at the other end. The steel cable may be a seven strand cable with a one inch diameter and has a length such that the brush 18 is suspended from the floor or ground as described above. The cable 26′ may be pressed at its respective ends so that the ends can be machined for connection to the gear assembly 22 and the second shaft 28. As shown in FIG. 6, the first shaft 26′ is machined to fit over the end of the second shaft 28 and a pin 31 inserted through the first shaft 26′ and second shaft 28 to secure the two components to one another. While the first shaft 26′ is described as being composed of a steel cable, the invention is not so limited and the first shaft 26′ may be composed of sufficient strength to support the brush 16 and sufficiently flexible to pivot when engaged by a cow.

The apparatus 10 may also be equipped with a motion sensor 44 or a proximity switch, which is in electrical communication with a controller 42, which in turn is in electrical communication with the motor 12 at contact box 46 and via cable 41, to activate the motor 12 when a cow approaches the brush 16 or engages the brush 16. An example of a motion sensor 42 that may be used with the apparatus infrared motion sensor, which has a field of view of about six feet. When the sensor 44 detects the presence of an approaching cow 15, the controller 42 is configured to activate the motor 12. The rotating brush 16 entices or encourages the cow 50 to approach and engage the brush 16 for grooming as shown in FIG. 3.

The controller 42 may be a variable frequency drive (“VFD”) controller with programmable logic control (PLC) that is for exampled housed in the control box 40. The PLC may be configured to control operations of the motor 12 to respond to various operating parameters or faults. By way of example the electrical current or power input to the motor 12 may be monitored to determine if a fault has occurred. The PLC may be configured to control the current to the motor so that the motor 12 always generates a desired torque output, or generates a torque output within some range of torque outputs, or to rotate at a desired rotational speed.

However, a number of conditions may cause the rotational velocity of the brush 16 to slow such as the brush 16 becoming clogged with debris, a cow collar becoming caught in the brush 16, the cow pushing on the brush causing the brush 16 to tilt at an undesired angle, two cows sandwiching the motor, etc. Under such conditions, the current to the motor 12 will be increased to increase torque output of the motor to maintain the desired rotation speed within the desired range of torque output. Accordingly, the PLC or controller 42 may be configured to control the motor 12 to perform one or more functions if the current exceeds a predetermined. threshold. That is, the controller 42 is configured to monitor the torque of the motor 12 and/or the current supplied to the motor 12, and to perform various functions based on if the current exceeds the predetermined threshold. Such functions may include stopping the rotation, reversing the direction, or reducing the rotation speed by limiting the maximum allowable torque to the motor 12—gear assembly 22 combination.

One may desire to have the brush 16 rotate at a desired rotational speed or within a range of speeds when a cow 15 is engaging the brush. When a cow 15 engages a rotating brush 16 the rotational speed will slow and the current to the motor 12 may be adjusted so the brush 16 rotates at the desired speed or within a speed range. That is, the torque output is increased because the rotating brush 16 is contacting the cow 15. The electrical current thresholds may be set according the demands of an operator or set accordance to the performance capabilities of motor. That is a threshold may be set according to a maximum rotational speed the motor is designed for operation. For example, the thresholds may be set at about 90% to about 150% of a current associated with a maximum rotational speed of the motor, and preferably the threshold is above 100% of the maximum current to avoid nuisance trips, and more preferably set toward 140% of maximum current to capture peak overload conditions or events. By monitoring current, one is indirectly monitoring torque output, which may be increased by the brush 16 getting jammed or clogged with a foreign object causing the motor 12 demand or pull more current to increase torque output.

Preferably, the PLC may be configured to generate such signals if the current exceeds the predetermined threshold a predetermined number of times and within a prescribed time duration. For example, the PLC, in response these parameters may generate a signal that reverses motor 12 and reverses the rotational direction of the brush 16. Alternatively, or in addition, the signals may stop and then restart the motor 12, or the signals may shut the motor 12 off. To that end, the control box 40 may be equipped with a visual indicator, such as a flashing light that is activated when the predetermined number of faults has been exceeded and action is required, or is activated when the motor 12 is shut off so that an operator is alerted to reset the motor. If the fault parameters have been exceeded as described, the PLC may be configured to trip a circuit breaker to prevent the motor 12 from being activated.

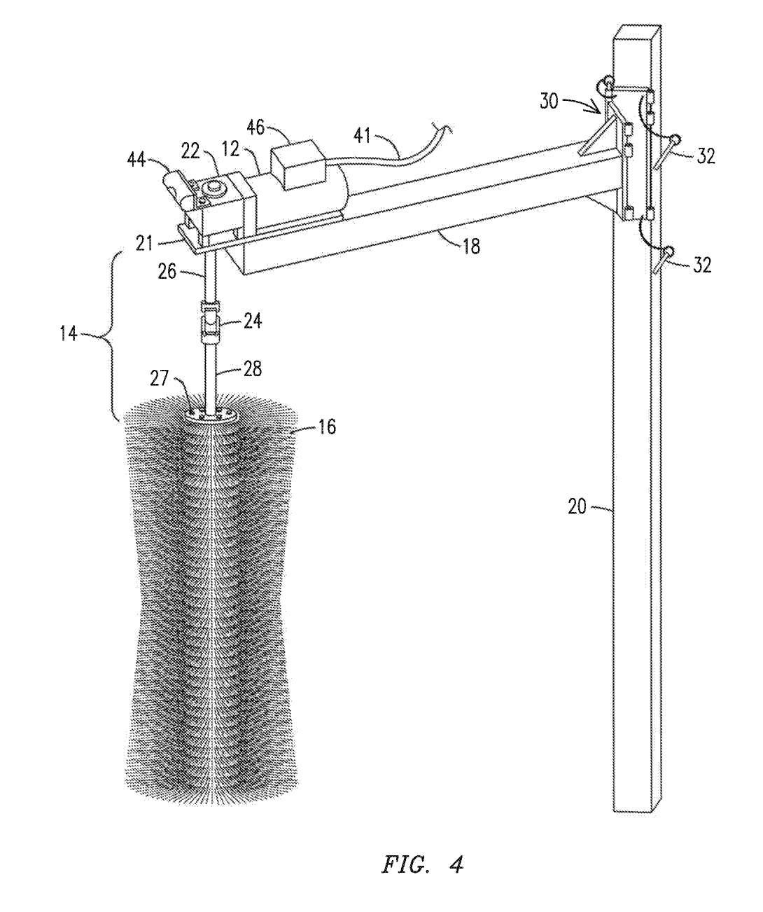

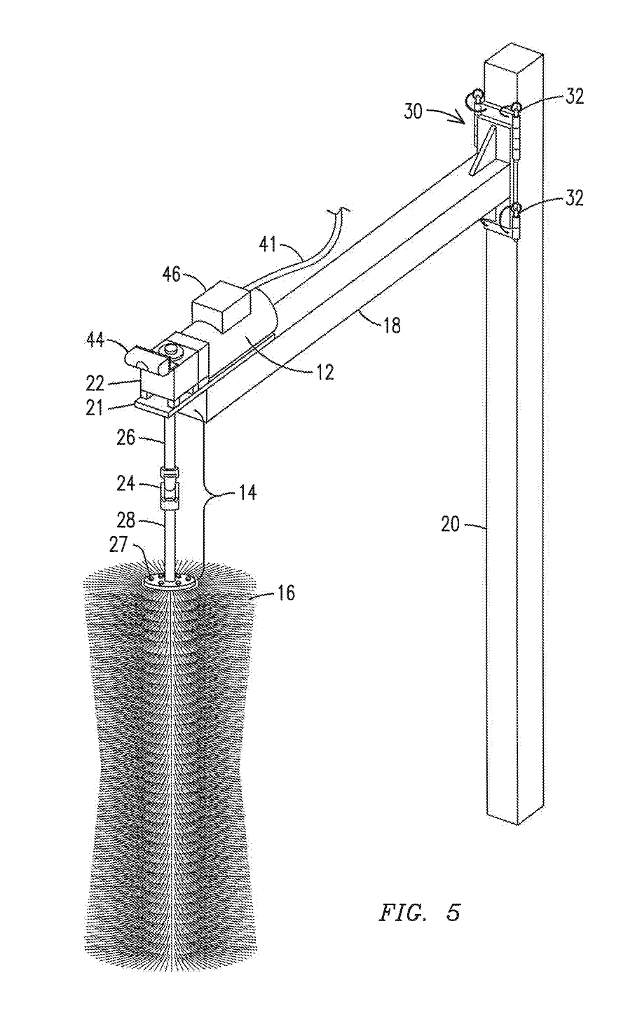

With respect to FIGS. 4 and 5, a cattle brush assembly 10 is shown in accordance with the present invention. In this embodiment the support beam 18 is mounted to a hinge mechanism 30 which is in turn mounted to a post 20. While the support beam 18 and hinge 30 are shown mounted to the post 20, the invention is not limited to the disclosed post 20, and the assembly 10 may be operatively mounted to any stationary support, such as a wall for example, that provides sufficient support for the operation of the apparatus 10. At times it may be necessary to move the brush 16 relative to its operating position to provide clearance for farm equipment or cattle to pass. Accordingly, the hinge 30 may be opened or actuated to move the brush 16 to provide clearance. As further shown in FIGS. 4 and 5, pins 32 may be provided to secure the hinge 30 in a closed position during operation. The pins 32 can be readily removed in order to pivot the support beam 18 and move the brush. FIG, 4 shows the cattle brush assembly 10 with the hinge mechanism 30 opened and the cattle brush 16 moved for clearance.

While certain embodiments of the present invention have been shown and described herein, such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. An apparatus for brushing cattle, comprising:
a motor mounted to a fixed support structure, and the motor remains stationary during operation of the apparatus;
a shaft assembly operatively connected to the motor and disposed vertically and downwardly relative the motor;
a brush attached to the shaft assembly distal to the motor, wherein the motor drives the output shaft causing the brush to rotate;
wherein the shaft assembly is pivotal at a location along the shaft assembly between the brush and the motor.

2. The apparatus of claim 1, wherein the shaft assembly includes a pivoting joint disposed between the motor and the brush.

3. The apparatus of claim 2, wherein the shaft assembly includes a first shaft connected to the motor, a second shaft connected to the brush and the pivoting joint connecting the first shaft to the second shaft.

4. The apparatus of claim 3, wherein the pivoting joint includes a universal joint.

5. The apparatus of claim 3, wherein the pivoting joint includes flexible cable.

6. The apparatus of claim 1, wherein the shaft assembly includes a first shaft section that is flexible and operatively connected to the motor at a first end, and is connected to a second rigid shaft section at a second end thereof and the brush is mounted to the second rigid shaft.

7. The apparatus of claim 1, further comprising a controller to monitor one or more operating parameters of the motor and to control operation of the motor in response to the operating parameters exceeding one or more thresholds.

8. The apparatus of claim 7, wherein the controller monitors the current supplied to the motor and in response to the current exceeding the threshold the controller generates one or more signals to control the operation of the motor.

9. The apparatus of claim 8, wherein the one or more signals generated by the controller reverses the motor and rotational direction of the brush, stops and restarts the motor, and/or stops the motor.

10. The apparatus of claim 7, wherein the controller is configured to generate one or more signals to control operation of the motor when the one or more operating parameters exceed the one or more thresholds a predetermined number of times within a predetermined time duration.

11. The apparatus of claim 1, wherein the fixed support structure comprises a horizontally disposed beam.

12. The apparatus of claim 11, wherein the support beam is operatively connected to a hinge mechanism which is mounted to a stationary support.

13. The apparatus of claim 1, wherein the brush is suspended a predetermined height above a floor such that brush cannot be tilted to an angle relative to a common vertical axis of the brush and shaft assembly that exceeds a predetermined angle.

14. The apparatus of claim 1, wherein a longitudinal axis of the motor is horizontally disposed and the apparatus further comprising a gear assembly connected to the motor and operatively connected to the shaft assembly.

15. An apparatus for brushing cattle, comprising:
a motor affixed to a support structure, and the motor remains stationary during operation of the apparatus;
a shaft assembly operatively connected to the motor, and disposed vertically and downwardly relative the motor and the support beam;
a brush attached to shaft assembly distal to the motor, wherein the motor drives the output shaft causing the brush to rotate; and,
a controller with programmable logic configured to monitor one or more operating parameters of the motor and to control operation of the motor in response to the one or more operating parameters exceeding one or more thresholds associated with the operating parameters.

16. The apparatus of claim 15, wherein the shaft assembly is pivotal at a location along the shaft assembly between motor and the brush.

17. The apparatus of claim 15, wherein the support structure includes a horizontally disposed beam.

18. The apparatus of claim 17, wherein the support beam is operatively connected to a hinge mechanism which is mounted to a stationary support.

19. The apparatus of claim 15, wherein the brush is suspended a predetermined height above a floor such that brush cannot be tilted to an angle relative to a common vertical axis of the brush and shaft assembly that exceeds a predetermined angle.

20. An apparatus for brushing cattle, comprising:
a motor affixed to a horizontally disposed support beam, and the motor remains stationary during operation of the apparatus;
a gear assembly operatively connected to the motor;
a shaft assembly operatively connected to the gear assembly, and disposed vertically and downwardly relative the motor and the support beam;
a brush attached to shaft assembly distal to the motor, wherein the motor drives the output shaft causing the brush to rotate; and,
wherein the output shaft is pivotal at a location along the shaft assembly between the gear assembly and the brush.

21. The apparatus of claim 20, wherein the support beam is operatively connected to a hinge mechanism which is mounted to a stationary support.

22. The apparatus of claim 20, further comprising a controller o monitor one or more operating parameters of the motor and to control operation of the motor in response to the operating parameters exceeding one or more thresholds.

23. The apparatus of claim 22, wherein the controller monitors the current supplied to the motor and in response to the current exceeding a threshold the controller generates one or more signals to control the operation of the motor.

24. The apparatus of claim 23, wherein the one or more signals generated by the controller reverses the motor and rotational direction of the brush, stops and restarts the motor, and/or stops the motor.

25. The apparatus of claim 22, wherein the controller is configured to generate one or more signals to control operation of the motor when the one or more operating parameters exceed the one or more thresholds a predetermined number of times within a predetermined time duration.

26. The apparatus of claim 22, further comprising a motion sensor to detect the presence of a cow approaching or near the brush and a controller that is configured to start the motor when the sensor detects the presence of a cow.
